(19) United States
(12) Patent Application Publication
(10) Pub. No.: US 2011/0027668 A1
(43) Pub. Date: Feb. 3, 2011

(54) HYDROGEN GENERATION FROM CHEMICAL HYDRIDES

(75) Inventors: In Tae Bae, Wrentham, MA (US); Steven Specht, Brookfield, CT (US)

Correspondence Address: HONEYWELL/SLW;Patent Services, 101 Columbia Road, P.O. Box 2245, Morristown, NJ, 07962-2245, US

(73) Assignee: Honeywell International Inc., Morristown, NJ (US)

(21) Appl. No.: 12/511,844

(22) Filed: Jul. 29, 2009

(51) Int. Cl. H01M 8/04; H01M 8/18; C10L 5/00; C01B 3/02; C01B 3/08

(52) U.S. Cl. 429/413; 44/504; 423/648.1; 423/658; 429/421

(57) ABSTRACT

A fuel source for a hydrogen generator is described. The fuel source includes a chemical hydride, at least one catalyst precursor and a hygroscopic salt. When one or more of the at least one catalyst precursor and hygroscopic salt contact water, a catalyst is formed for facilitating the generation of hydrogen from the chemical hydride.

### BACKGROUND

An electrochemical cell is a device capable of providing electrical energy from an electrochemical reaction, typically between two or more reactants. Generally, an electrochemical cell includes two electrodes, called an anode and a cathode, and an electrolyte disposed between the electrodes. In order to prevent direct reaction of the active material of the anode and the active material of the cathode, the electrodes are electrically isolated from each other by a separator.

In one type of electrochemical cell, sometimes called a hydrogen fuel cell, the anode reactant is hydrogen gas, and the cathode reactant is oxygen (e.g., from air). At the anode, oxidation of hydrogen produces protons and electrons. The protons flow from the anode, through the electrolyte, and to the cathode. The electrons flow from the anode to the cathode through an external electrical conductor, which can provide electricity to drive a load. At the cathode, the protons and the electrons react with oxygen to form water. The hydrogen can be generated from a hydrogen storage alloy, by ignition of a hydride, or by hydrolysis of a liquid solution or slurry of a hydride.

Hydrogen fuel cell technology has become a strong candidate for a consumer electronics power source owing to intensive research and development efforts in proton exchange membrane (PEM) fuel cells for the past decade or so. However, there is no appropriate hydrogen storage/generation technology that has been practical for portable applications, delaying its commercialization.

It has long been known that hydrogen gas can be effectively generated from hydrolysis of chemical hydrides, such as sodium borohydride, reacting with water when an appropriate catalyst is used. However, implementing this scheme requires a complicated control system of chemical hydride and water mixing to meet the demand of hydrogen flow rate at a given fuel cell power requirement. Adding the control system and the amount of water to the chemical hydride results in a loss of competitiveness as a portable power source due to the poor energy density of the overall fuel cell system compared to rechargeable batteries.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates a flow diagram of a method of using a fuel source for an electrochemical cell, according to some embodiments.

FIG. 2 illustrates a block diagram of a power generator utilizing a fuel source, according to some embodiments.

FIG. 3 illustrates a graphical view of a hydrogen generation profile from NaBH₄ hydrolysis, according to some embodiments.

### SUMMARY

A fuel source for a hydrogen generator includes a chemical hydride, at least one catalyst precursor and a hygroscopic salt. When one or more of the at least one catalyst precursor and hygroscopic salt contact water, a catalyst is formed for facilitating the generation of hydrogen from the chemical hydride.

A method of using a fuel source for a hydrogen generator includes contacting at least one catalyst precursor and a hygroscopic salt sufficient to form a catalyst precursor mixture, contacting the catalyst precursor mixture with water sufficient to form a catalyst and contacting the catalyst and a chemical hydride with water sufficient to generate hydrogen.

An electrochemical cell system includes a fuel source and one or more electrochemical cells configured to utilize the hydrogen generated from the fuel source for operation. The fuel source includes a chemical hydride, at least one catalyst precursor and a hygroscopic salt. When one or more of the at least one catalyst precursor and hygroscopic salt contact water, a catalyst is formed for facilitating the generation of hydrogen from the chemical hydride.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense, and the scope of the present invention is defined by the appended claims and their equivalents.

In this document, the terms “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

Embodiments of the invention relate the use of chemical hydrides as a hydrogen generation source for electrochemical cells, such as fuel cells. The fuel source utilizes a catalytic precursor and hygroscopic salt to generate a catalyst in situ. One example of such a chemical hydride includes sodium borohydride. In a solid form, sodium borohydride is stable in a normal ambient condition and self decomposition is slow. Alone, it is not hygroscopic. When it is mixed with a hygroscopic catalyst precursor, borohydride may undergo hydrolysis by taking water vapor from the ambient. The hydrogen generation rate by hydrolysis in this scheme may depend on the humidity of the ambient or water supplied to the fuel source, the content of a catalyst or a catalyst precursor and the equilibrium water vapor pressure of the hygroscopic precursor or the catalyst.

One embodiments of the invention relates to a powder of sodium borohydride mixed with a small quantity of hygroscopic transition metal salt as a hydrolysis catalyst precursor, prepared in a pellet form. The pellet may generate hydrogen as the hygroscopic salt absorbs water vapor from the ambient, reacts with borohydride forming a corresponding catalyst and consequently results in a borohydride hydrolysis.

This method of hydrogen generation has several advantages over conventional hydrogen generation from chemical hydrides. The hydrogen generator does not need to carry water. Thus, it becomes volume-efficient and suitable for small portable hydrogen fuel cells. A water-mixing controller that is required in the water-carrying system is not needed. Thus, the system becomes cost efficient. The energy density is high compared to conventional technology. Sodium borohydride is less expensive compared to other chemical hydrides, such as lithium aluminum hydride. The reaction rate may be easily set by adjusting the content of a catalyst precursor in the pellet. However, this method is not limited to the hydride reaction with the ambient moisture but also the reaction with the water vapor generated artificially or by natural evaporation from a water storage compartment of an electrochemical cell system.

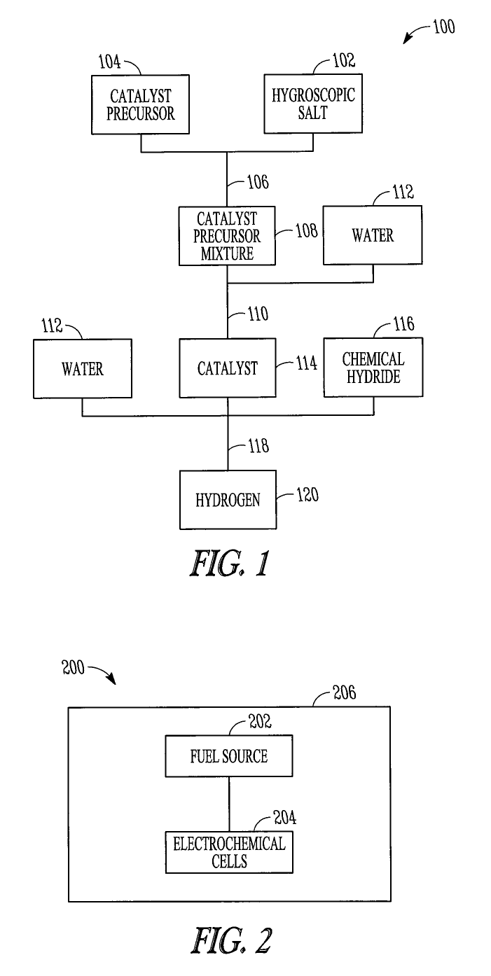

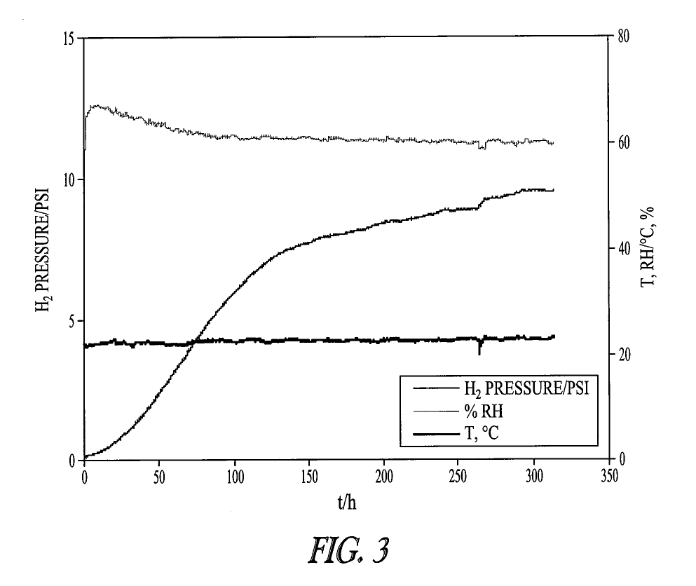

Referring to FIG. 1, a flow diagram 100 of a method of using a fuel source for an electrochemical cell is shown, according to some embodiments. At least one catalyst precursor 104 and a hygroscopic salt 102 may be contacted 106, sufficient to form a catalyst precursor mixture 108. The catalyst precursor mixture 108 may be contacted 110 with water 112, sufficient to form a catalyst 114. The catalyst 114 and a 116 chemical hydride may be contacted 118 with water 112, sufficient to generate hydrogen 120. Contacting 106, 110, 118 may include physically or chemically contacting, for example. Contacting 106 may include mixing or compressing, for example. The catalyst precursor 104 and hygroscopic salt 102 may be mixed prior to forming a fuel source with the chemical hydride 116 or simultaneously with the chemical hydride 116, for example. The fuel source 202 may be in contact with one or more electrochemical cells 204, such as fuel cells, within a power generator or electrochemical cell system 206 (see view 200 of FIG. 2).

For fuel cell applications, sodium borohydride may be used for hydrogen generation following the chemical reaction below.

NaBH₄+2H₂O→NaBO₂+4H₂ ΔH=217 kJ/mol

Although this reaction is thermodynamically favorable as a large quantity of heat generation indicates, the hydrolysis rate of borohydride in pure water may be negligibly small. Transition metals, including noble metals, may accelerate the reaction rate greatly. Finely dispersed metal particles are commonly used as a catalyst for practical hydrogen generation.

Another embodiment may include using a catalyst precursor. A transition metal salt as the precursor may be added either to water making a precursor solution or to borohydride making a solid mixture. For example, when CoSO₄ is used, Co²⁺ may be readily reduced by borohydride generating cobalt catalyst particles in situ by the reaction below.

BH₄⁻+4Co²⁺+2H₂O→BO₂⁻+4Co+8H⁺

Thus, 1 g of CoSO₄ may consume 0.061 g of NaBH₄ and 0.058 g of water (or 0.058 cc of water) stoichiometrically. Therefore, the complete reaction of 1 g NaBH₄ and 0.1 g CoSO₄ requires 0.95 g water and generates 0.21 g H₂. When this hydrogen is used in a fuel cell or other electrochemical cell running at an total efficiency of 50% and only weights and volumes of reactants are considered, the theoretical specific energy of this reaction schemes becomes about 1.7 Whig and then, the corresponding volumetric energy density (using the density values 1.07 and 3.71 for NaBH₄ and CoSO₄) respectively, is 1.81 Wh/cc. However, the amount of water practically required for complete reaction is much more than the stoichiometric values since the water vapor generated by the heat of reaction is carried away with hydrogen gas generated. In addition, water access to the reactant may be hampered by the hygroscopic nature of the reaction products. Thus, 2 to 3 times the stoichiometric amount is conventionally used, resulting in an energy density lower than a half of the theoretical value.

In a small fuel cell system, where a high rate of hydrogen consumption may not required, hydrogen generation by hydrolysis of a chemical hydride may rely on water vapor in the ambient. For example, lithium aluminum hydride LiAlH₄ is hygroscopic, absorbs water from the ambient and readily undergoes hydrolysis without any catalysts, generating hydrogen (for example, see U.S. Published Patent Application No. 2007/0104996A1, the disclosure of which is herein incorporated by reference).

LiAlH₄+4H₂O→LiOH+Al(OH)₃+4H₂

In this waterless mode of operation, the specific energy may be 3.5 Wh/g and the volumetric energy density is 3.2 Wh/cc at 50% fuel cell efficiency.

Embodiments of this invention may describe several methods of hydrogen generation using inactive chemical hydrides such as sodium borohydride pre-mixed with catalysts or catalyst precursors.

### Example 1

This method utilized a mixture of a chemical hydride with a hygroscopic transition metal salt and the reaction of this mixture with water vapor from the ambient to generate hydrogen. Catalyst particles were in situ generated from the transition metal salt. For example, NaBH₄ was mixed and ground with CoCl₂ at 1% by weight. Then, the mixture was pressed as a pellet. This pellet was exposed to the ambient humidity to generate hydrogen. FIG. 2 shows hydrogen pressure rise with time for 0.38 g pellet in a closed chamber set for 60% relative humidity at the room temperature (see FIG. 2, Hydrogen generation profile from NaBH₄ hydrolysis). The pellet contained 0.37 g NaBH₄ and 0.005 g CoCl₂. The volume of the reactor was 1.15 liter. About 80% of NaBH₄ was consumed at 310 h.

TABLE I
Comparison of catalyst-premixed NaBH₄ and LiAlH₄

| | | specific | effective | hydrogen | theoretical | price |
|---|---|---|---|---|---|---|
| | Mw | gravity g/cc | hydride/cc | in moles | energy, Wh | $/lb |
| LAH | 38.0 | 0.917 | 0.917 | 0.0965 | 6.36 | 250 |
| NBH | 37.8 | 1.074 | 1.064 | 0.113 | 7.42 | <100 |
| | | | (0.01 g | | | |
| | | | catalyst)* | | | |

*Consumption of NaBH₄ in generating the catalyst from the precursor is negligible as calculated in the text.

As Table I indicates, the premixed NaBH₄ system for hydrogen generation is definitely advantageous over LiAlH₄ in the volumetric energy density and its cost. In addition, it is much easier to handle and process premixing of NaBH₄ than LiAlH₄, which requires a strictly controlled environment.

Fine metal particles of Co, Fe, Ni, Cu, Mn, Cr, Ti, V, Zn, Zr, Nb, Mo, Ru, Pd, Ag, Pt, Ir, Os, W, In, Sn, Ta are all good catalysts. Thus, their water-soluble salts of halide, nitrate, sulfate, acetate, phosphate, and carbonate may be used as the precursor.

Hygroscopic salts may include CaSO₄, KCH₃CO₂, alkali hydroxides, CaCl₂ ZnCl₂, CoCl₂, CuCl₂, FeCl₃, NiCl₂, nitrate salts or a combination thereof.

### Example 2

A chemical hydride was mixed with a desired catalyst precursor and a hygroscopic salt for hydrolysis of the hydride by absorbing water vapor from a certain source such as ambient air, a vapor/mist generator, or natural evaporation. For example, NaBH₄ was mixed with a small amount of CoSO₄ and anhydrous CaCl₂. Calcium chloride takes water, hydride in the vicinity reduces Co²⁺ to Co metal, in situ generating catalyst particles and hydrogen was generated at the surface of the Co metal in contact with the hydride. Since the reaction rate (i.e., hydrogen generation rate) depends on the catalyst surface area and the humidity (i.e., water vapor pressure), it was controlled by adjusting the precursor content and the type of the hygroscopic salt (its equilibrium water vapor pressure).

### Example 3

In this method, a pre-formed catalyst, instead of a precursor salt, was dispersed in the hydride solid matrix. A hygroscopic salt was also mixed as in Example 2. Consumption of the hydride in the forming catalysts from the precursor was eliminated in this method. The catalysts were supported on high area inert medium such as activated carbon, silica, and etc.

A 0.4 g pellet of NaBH₄+1% CoCl₂ compressed at 5000-15000 psi with a 100% head space (to allow the volume expansion as the reaction proceeds) gave the best results to generate hydrogen at 5-20 cc hydrogen when about 1 cm² of the pellet was exposed to 50% relative humidity.

Based on the number above, the exposure area of pellets and the number of pellets can be programmed for the hydrogen demand.

In order to generate hydrogen at a steady rate until the exhaustive completion of the hydride reaction, hydride pellets may be prepared with a catalyst precursor concentration gradient within the pellet in which inner parts or portion have gradually higher catalyst precursor concentrations.

Hydride pellets may be prepared by mixing hydride with the catalyst precursor uniformly but at several different concentrations. Then the pellets may be stacked in a way that inner pellets have gradually higher concentrations of the catalyst or the catalyst precursor to maintain steady hydrogen generation until the hydride exhaustion. When they are stacked, inner ones react may react later and slower at the same concentration of salts and/or catalysts. For steady operations, the pellets of higher catalyst/salt concentration may be placed inside the stacking. This can give another variation in such a way that the inner pellets have more strongly hygroscopic salts.

What is claimed is:

1. A fuel source for a hydrogen generator, comprising:
a chemical hydride;
at least one catalyst precursor; and
a hygroscopic salt;
wherein when one or more of the at least one catalyst precursor and hygroscopic salt contact water, a catalyst is formed for facilitating the generation of hydrogen from the chemical hydride.

2. The fuel source of claim 1, wherein the fuel source comprises a pellet.

3. The fuel source of claim 1, wherein the chemical hydride comprises sodium borohydride.

4. The fuel source of claim 1, wherein the at least one catalyst precursor comprises one or more water-soluble salts of halides, nitrates, sulfates, acetates, phosphates, carbonates and Co, Fe, Ni, Cu, Mn, Cr, Ti, V, Zn, Zr, Nb, Mo, Ru, Pd, Ag, Pt, Ir, Os, W, In, Sn, Ta or a combination thereof.

5. The fuel source of claim 1, wherein the hygroscopic salt comprises one or more of CaSO₄, KCH₃CO₂, alkali hydroxides, CaCl₂ ZnCl₂, CoCl₂, CuCl₂, FeCl₃, NiCl₂, nitrate salts or a combination thereof.

6. The fuel source of claim 1, wherein the catalyst comprises particles of one or more of Co, Fe, Ni, Cu, Mn, Cr, Ti, V, Zn, Zr, Nb, Mo, Ru, Pd, Ag, Pt, Ir, Os, W, In, Sn and Ta.

7. The fuel source of claim 1, wherein the at least one catalyst precursor and hygroscopic salt pre-mixed.

8. The fuel source of claim 2, wherein the pellet comprises a concentration gradient of the catalyst precursor.

9. The fuel source of claim 8, wherein an inner portion of the pellet comprises a higher concentration on the concentration gradient of the catalyst precursor as an outer portion of the pellet.

10. The fuel source of claim 2, wherein two or more pellets are stacked.

11. The fuel source of claim 10, wherein inner pellets within the stacked pellets have a higher concentration of catalyst, hygroscopic salt or both.

12. A method of using a fuel source for a hydrogen generator, comprising:
contacting at least one catalyst precursor and a hygroscopic salt, sufficient to form a catalyst precursor mixture;
contacting the catalyst precursor mixture with water, sufficient to form a catalyst;
contacting the catalyst and a chemical hydride with water, sufficient to generate hydrogen.

13. The method of claim 12, wherein the at least one catalyst precursor comprises one or more water-soluble salts of halides, nitrates, sulfates, acetates, phosphates, carbonates and Co, Fe, Ni, Cu, Mn, Cr, Ti, V, Zn, Zr, Nb, Mo, Ru, Pd, Ag, Pt, Ir, Os, W, In, Sn, Ta or a combination thereof.

14. The method of claim 12, wherein the hygroscopic salt comprises one or more of CaSO₄, KCH₃CO₂, alkali hydroxides, CaCl₂ ZnCl₂, CoCl₂, CuCl₂, FeCl₃, NiCl₂, nitrate salts or a combination thereof.

15. The method of claim 12, wherein the catalyst comprises particles of one or more of Co, Fe, Ni, Cu, Mn, Cr, Ti, V, Zn, Zr, Nb, Mo, Ru, Pd, Ag, Pt, Ir, Os, W, In, Sn and Ta.

16. The method of claim 12, further comprising contacting the catalyst precursor mixture and the chemical hydride prior to contacting with water.

17. The method of claim 12, further comprising contacting the generated hydrogen with one or more fuel cells.

18. The method of claim 12, wherein the water is from ambient.

19. The method of claim 12, wherein the water is produced by a fuel cell reaction.

20. An electrochemical cell system, comprising:
a fuel source, including:
a chemical hydride;
at least one catalyst precursor; and
a hygroscopic salt;
wherein when one or more of the at least one catalyst precursor and hygroscopic salt contact water, a catalyst is formed for facilitating the generation of hydrogen from the chemical hydride; and
one or more electrochemical cells, configured to utilize the hydrogen generated from the fuel source for operation.

21. The electrochemical cell system of claim 20, wherein the one or more electrochemical cells comprise fuel cells.
